(19) United States
(12) Patent Application Publication
(10) Pub. No.: US 2026/0201157 A1
(43) Pub. Date: Jul. 16, 2026

(54) CHROMIUM ACID ETCHING FREE METAL PLATING OF BLENDS OF ACRYLONITRILE-BUTADIENE-STYRENE AND POLAR POLYMER

(71) Applicant: SABIC Global Technologies B.V., Bergen op Zoom (NL)

(72) Inventors: Amit Kumar Tevtia, Bangalore (IN); Mohammed Ashraf Moideen, Bengaluru (IN); Dhanabalan Anantharaman, Bengaluru (IN); Radha Kamalakaran, Bengaluru (IN)

(21) Appl. No.: 19/134,102

(22) PCT Filed: Nov. 30, 2023
(86) PCT No.: PCT/EP2023/083672

§ 371 Date: May 29, 2025

(51) Int. Cl. C08L 25/12; C08J 3/20; C08K 3/22; C08K 5/098; C08K 5/20; C23C 18/16; C23C 18/24; C23C 18/28; C23C 18/30; C23C 18/38; C25D 5/56

(52) U.S. Cl. CPC C08L 25/12; C08J 3/201; C08K 3/22; C08K 5/098; C08K 5/20; C23C 18/1641; C23C 18/24; C23C 18/285; C23C 18/30; C23C 18/38; C25D 5/56; C08J 2325/12; C08J 2423/08; C08J 2429/04; C08J 2439/06; C08J 2451/04; C08K 2003/222; C08L 2203/30; C08L 2205/035; C08L 2207/324

(57) ABSTRACT

Thermoplastic compositions are described. A thermoplastic composition can include (a) a copolymer having units derived from a vinyl aromatic monomer and a vinyl nitrile monomer; (b) a rubber modified thermoplastic polymer; (c) a polar polymer that includes a carboxylic acid, an alcohol, or a combination thereof; and (d) optional processing additives. Metal plated articles that include the thermoplastic polymer composition are also described. The thermoplastic composition can have an improved yellowness index (YI) when compared with a similar composition that does not include the polar polymer.

### CROSS-REFERENCE TO RELATED APPLICATIONS

This application claims the benefit of priority to European Patent Application No. 22211169, filed Dec. 2, 2022, the entire contents of which are hereby incorporated by reference in their entirety.

### TECHNICAL FIELD

The invention relates to thermoplastic polymer compositions and methods for producing thermoplastic compositions.

### BACKGROUND ART

Polymeric plastic parts prepared from a thermoplastic material such as an acrylonitrile-butadiene-styrene (ABS) polymer are often metalized when used for certain application such as an automotive application. The thermoplastic material functions as a polymeric substrate on which a metal coating can be deposited. For example, polymeric plastic parts prepared from an ABS polymer can be coated with a metal layer in order to impart a mirror finish look to resemble a metal part while retaining the distinct advantage of being lightweight. In addition, metal coatings can improve the mechanical strength, thermal stability, and chemical resistance of the underlying polymeric substrate on which the metal is coated. In this regard, ABS polymers are particularly useful for automotive and other industrial application on account of their desirable impact property and other useful features.

There is an issue with the use of metal coatings on polymeric plastic parts. Metal coatings suffer in that they do not easily bond or adhere to most polymer-based substrates unless the surfaces of such polymeric substrates are first chemically treated. Conventionally, surface of the polymeric substrates can be chemically etched with oxidizing reagents such as hexavalent chromium trioxide or a mixture of chromic/sulfuric acids or chromic/sulfuric/phosphoric acids. These strong oxidizing agents can micro-roughen and chemically alter the surface of the polymeric substrate by forming polar organic functional groups such as R—COOH, R—OH, R—SO₃, and R—CH═O at the surface of the substrate. The presence of these polar groups can promote adsorption of plating catalysts from aqueous solutions that allow subsequent metal deposition to occur during the plating process. After the etching process, the surface of the polymeric substrate can be metal plated. One suitable metric to measure the success of bonding between the metal layer and the polymer substrate is the peel strength, where greater peel strength correlates to better adherence of the metal on the polymer substrate.

However, the use of hexavalent chromium compounds such as chromium trioxide pose certain risks and challenges such as 1) health risks on account of such compounds being extremely carcinogenic, 2) disposal of waste effluents derived from the etching process, which render such etching process not only environmentally hazardous but also expensive, 3) purification of the etched plastic parts to remove any residual chromium trioxide that may be present as impurities as such impurities adversely affect the metal plating process, and/or 4) use of highly oxidizing acid solution may often damage the polymeric substrate itself or render it structurally weak for metal plating.

In an effort to avoid these problems, many alternative processes to chromic acid etching have been investigated. For example, dry plasma etching processes was proposed as an alternative for the wet etching process. However, application of this method is only limited to flat polymeric parts. Alternatively, etching reagents such as potassium permanganate have been used in an attempt to replace chromic acid. Although, the use of heated alkaline permanganate solutions has seen some limited commercial success, owing to its slower oxidizing rate compared to chromic acid, applicability of permanganate solutions has mostly been limited.

Another problem associated with ABS resins is that they can yellow during extrusion and/or molding processes. In particular, the yellowish appearance of the molded parts restricts their use in the applications in which visual appearance and surface aesthetics are important. The yellow coloration of ABS resins can be ascribed to the presence of a divinyl component, which upon exposure to heat oxidizes to generate the yellowing color. During melt processing, the ABS color can turn yellow under the effects such as heat, oxygen, stress, micro-moisture, impurity, etc. How quickly an ABS resin yellows is often times measured by its yellowness index (YI). A lower YI correlates with a more stable color, whereas a higher YI correlates with a less stable color. Lower YI is desired. While efforts to improve the YI of ABS resins has been ongoing, many of these efforts can lead to reduction of the physical and/or mechanical properties of the resins as well.

### SUMMARY OF THE INVENTION

A solution to at least one of the problems associated with metal plating and/or yellowing of polymeric substances has been discovered. The solution can include a thermoplastic polymer composition that includes (a) a copolymer having units derived from a vinyl aromatic monomer and a vinyl nitrile monomer, (b) a rubber modified thermoplastic polymer, (c) a polar polymer that includes a carboxylic acid, an alcohol, or a combination thereof, and (d) a melt-processing additive. In some embodiments of the invention, such a polymeric composition can be successfully metal plated. The success can be determined by a peel strength test. Advantageously, the thermoplastic composition, when presented in a molded form, can have a suitable impact strength. This can allow such a polymeric composition to be used for preparing metal plated articles suitable for various industrial applications that desire materials to have excellent impact strength. Also, and in one aspect, polymeric compositions of the present invention can be coated with metal without having to use chemical etching processes that rely on oxidizing reagents such as hexavalent chromium trioxide or a mixture of chromic/sulfuric acids or chromic/sulfuric/phosphoric acids.

In some embodiments, the polymeric compositions of the present invention can have a low YI as compared to ABS resins without a polar polymer. In particular, it was discovered that the polar polymer portion of the polymeric compositions of the present invention can lower the YI and increase the whiteness (L value) of the resin. This can be advantageous, as it can allow the compositions of the present invention to be metal coated while having improved whiting in the material. Without wishing to be bound by theory, it is believed that the reduced YI of the compositions of the present invention can be attributed to the reaction of polar groups of polar polymers with colored impurities generated during the production and/or melt processing of ABS. The polar polymer (C) is capable of migrating to at least a portion of a surface of the polymer composition. The migration of the polar polymer (C) can be initiated or quickened, or both, while holding the polymer melt in the mold. Additionally, low molecular weight of polar polymer (C) (e.g., a molecular weight of 5,000 g/mole to 25,000 g/mole) and/or the presence of polar components from hydrolysis of polar polymer (C) (e.g., acrylic acid or hydrolyzed polyvinyl acetate) can allow the polar polymer (C) to migrate to the surface of the polymeric compositions of the present invention. The additive migrating to the surface helps to retain most of the bulk properties.

In one aspect of the present invention thermoplastic compositions are described. A thermoplastic polymer composition can include, based on the total weight of the thermoplastic composition, (a) 30 wt. % to 79 wt. %, preferably 60 wt. % to 75 wt. %, more preferably 62 wt. % to 72 wt. % of a copolymer (A) comprising units derived from (i) a vinyl aromatic monomer and (ii) a vinyl nitrile monomer, (b) 20 wt. % to 50 wt. %, preferably 20 wt. % to 30 wt. %, more preferably 22 wt. % to 24 wt. % of a rubber modified thermoplastic polymer (B), (c) greater than 1 wt. % to 15 wt. %, preferably 1 wt. % to 13 wt. %, more preferably 3 wt. % to 10 wt. % of a polar polymer (C) comprising a carboxylic acid, an alcohol, an amide, or a combination thereof, and (d) greater than 0 wt. % to 5 wt. %, preferably 1 wt. % to 2 wt. % more preferably 1.2 wt. % to 1.5 wt. % of processing additives (e.g., magnesium oxide (MgO), silicone fluid, ethylenebisstearamide (EBX) wax, magnesium stearate, or a mixture thereof). In some embodiments, a lubricant processing additive can be removed from the thermoplastic compositions of the present invention. For example, ethylene-acrylic acid copolymer (polar polymer (C)) can act as a lubricant.

The vinyl aromatic monomer of copolymer (A) can include styrene, α-methyl styrene, dibromostyrene, vinyltoluene, vinylxylene, butylstyrene, p-hydroxystyrene, methoxystyrene, or any combination thereof. The vinyl nitrile monomer of copolymer (A) can include acrylonitrile, alpha-chloro acrylonitrile, methacrylonitrile, ethacrylonitrile, or any combination thereof. In a preferred aspect, the vinyl aromatic monomer can be styrene (S) and the vinyl nitrile monomer can be acrylonitrile (AN).

The rubber modified polymer (B) can include a polymeric rubber and a thermoplastic copolymer grafted to the polymeric rubber. The polymeric rubber can include polymeric units derived from a conjugated diene, wherein the conjugated diene can include 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, or any combination thereof. The grafted thermoplastic copolymer (D) can include polymeric units derived from: (i) a vinyl aromatic monomer that can include styrene, α-methyl styrene, dibromostyrene, vinyltoluene, vinylxylene, butylstyrene, p-5 hydroxystyrene, methoxystyrene, or any combination thereof, (ii) a vinyl nitrile monomer that can include acrylonitrile, methacrylonitrile, ethacrylonitrile, or any combination thereof, and (iii) optionally, a (meth)acrylic monomer that can include methyl methacrylate, ethyl methacrylate, methyl acrylate, ethyl acrylate, propyl acrylate, propyl methacrylate, or any combination thereof.

In preferred aspects, the polymeric rubber can include polymeric units derived from 1,3-butadiene, a grafted polymeric rubber copolymer (D) derived from styrene polymeric units, acrylonitrile monomer, and optionally methylmethacrylate monomer. In a preferred aspect, the copolymer (A) can be styrene-acrylonitrile copolymer (SAN) and the rubber modified thermoplastic polymer (B) can be polybutadiene rubber grafted with styrene/methyl methacrylate/acrylonitrile copolymer. The combination of copolymer (A) and rubber modified thermoplastic polymer (B) can produce acrylonitrile-butadiene-styrene (ABS).

The polar polymer (C) can have a molecular weight from 5,000 g/mole to 25,000 g/mole. In some aspects, polar polymer (C) can be oligomeric or has a low molecular weight. In some aspects, the polar polymer (C) can include an ethylene-acrylic acid copolymer, a polyvinylpyrrolidone polymer, a polyvinyl alcohol polymer, or a blend thereof. The ethylene-acrylic acid copolymer can include 1 wt. % to 10 wt. %, preferably 6.9 wt. % acrylic acid based on the total weight of polar polymer (C) and/or the polyvinyl alcohol polymer can include 70 wt. % to 80 wt. % hydrolyzed polyvinyl acetate based on the total weight of polar polymer (C).

In some aspects, the thermoplastic composition of the present invention can have a Notched Izod Impact strength of 3.0 kJ/m² to 30.0 kJ/m², preferably 4.0 kJ/m² to 25.0 kJ/m², more preferably 5.0 kJ/m² to 20.0 kJ/m², when measured in accordance with ISO 180/1A. A portion or all of the thermoplastic composition can be molded. A portion or all of the surface of the molded thermoplastic composition can be surface treated. A metallic coating can be adhered to a least a portion of the treated surface.

In some aspects, the thermoplastic polymer composition of the present invention can have a yellowness index (YI) less than the thermoplastic polymer composition absent polar polymer (C). The yellowness index of the thermoplastic polymer composition of the present invention can be less than 30, preferably less than 27, more preferably less than 22, or from 2 to 30, preferably 20 to 27. The thermoplastic polymer composition can have increased white lightness (e.g., appear whiter) as compared to the thermoplastic polymer composition absent polar polymer (C). Other aspects of the invention describe processes for reducing a yellowness index of the thermoplastic polymer composition of the present invention. A process can include, melt-blending a thermoplastic composition that includes: (a) 30 wt. % to 79 wt. % of a copolymer (A) comprising units derived from a vinyl aromatic monomer and a vinyl nitrile monomer; (b) 20 wt. % to 50 wt. % of a rubber modified thermoplastic polymer (B); (c) 1 wt. % to 15 wt. % of a polar polymer (C) comprising a carboxylic acid, an alcohol, an amide, or a combination thereof; and (d) a melt-processing additive.

Thermoplastic compositions of the present invention can be included in articles of manufacture.

In some aspects, metal plated articles that include the thermoplastic composition of the present invention are described. The metal can be adhered to at least a portion of a surface of the thermoplastic composition. Non-limiting examples of metals include copper, chromium, nickel, or a combination thereof.

In other aspects of the present invention, processes to produce the thermoplastic composition of the present invention are described. A process can include melt-blending 30 wt. % to 79 wt. % of copolymer (A), 20 wt. % to 50 wt. % of rubber modified thermoplastic polymer (B), greater than 1 wt. % to 15 wt. % of polar polymer (C), and greater than 0 wt. % to 5 wt. % optional processing additives. In some aspects, thermoplastic composition can be molded into an article. In some instances, the article can be surface treated by contacting the article with a chemical agent under conditions suitable to surface treat the article of the present invention. Non-limiting examples of the chemical agent include a suspension of manganese oxide colloidal particles in a mineral acid mixture. The mineral acid mixture can include sulfuric acid and phosphoric acid. The surface treated article of the present invention can be subjected to conditions suitable to adhere a metal layer to at least a portion of the treated surface to produce a metal plated portion of the article.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The term “treated surface” can refer to a portion of a surface of a thermoplastic composition (including, for example, a molded thermoplastic composition) of the present invention that has been exposed to, for example, a chemical reagent.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, which includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The thermoplastic compositions of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the thermoplastic composition of the present invention are their abilities to enhance metal coatings to adhere to a surface of the thermoplastic composition.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A and 1B are graphical representations of notched izod impact (NII) values of a comparative thermoplastic composition (C10 and C11 in FIGS. 1A and 1, respectively) and the thermoplastic compositions of the present invention with different amounts of polar polymer (C) (F10, F11, F13 and F14 in FIG. 1A; and F15 and F16 in FIG. 1B).

FIGS. 2A and 2B are graphical illustrations of Vicat softening temperature (VST) of a comparative thermoplastic composition (C10 and C11 in FIGS. 2A and 2B, respectively), and thermoplastic compositions of the present invention with different amounts of polar polymer (C) (F10, F11, F13, and F14 in FIG. 2A; and F15 and F16 in FIG. 2B).

FIG. 3 is a graphical representation of (HDT) measurements of a comparative thermoplastic composition (C11) and thermoplastic compositions of the present invention with different amounts of polar polymer (C) (F15 and F16).

FIG. 4 is an illustration of molded bars of thermoplastic compositions of the present invention with different amounts of polar polymer (C) and a molded bar of ABS depicting the whiteness.

FIG. 5 shows scanning electron microscopy (SEM) images of manganese colloid particles containing mineral acid pretreated molded plaques of a comparative thermoplastic composition. The manganese colloid containing acid solution was prepared by mixing H₃PO₄ (219 mL/L), H₂SO₄ (573 mL/L or 605 mL/L), MnO₂ (60 g/L). All pretreatments were conducted at 70° C. Top SEM is pretreatment for 10 minutes using 573 mL/L H₂SO₄ at 8000 & 2000× magnification. Second SEM image is pretreatment for 10 minutes using 605 mL/L H₂SO₄ at 8000 & 2000× magnification. Third SEM is pretreatment for 20 minutes using 573 mL/L H₂SO₄ at 8000 & 2000× magnification. Bottom SEM is pretreatment for 20 minutes using 605 mL/L H₂SO₄ at 8000 & 2000× magnification.

FIG. 6 shows SEM images of manganese colloid acid pretreated molded plaques of a thermoplastic composition of the present invention with a polar polymeric additive (3 wt. % PE-AA). The manganese colloid acid solution was prepared by mixing H₃PO₄ (219 mL/L), H₂SO₄ (573 mL/L or 605 mL/L), MnO₂ (60 g/L). All pretreatments were conducted at 70° C. Top SEM is pretreatment for 10 minutes using 573 mL/L H₂SO₄ at 8000 & 500× magnification. Second SEM image is pretreatment for 10 minutes using 605 mL/L H₂SO₄ at 8000 & 500× magnification. Third SEM is pretreatment for 20 minutes using 573 mL/L H₂SO₄ at 8000 & 500× magnification. Bottom SEM is pretreatment for 20 minutes using 605 mL/L H₂SO₄ at 8000 & 500× magnification.

FIG. 7 shows SEM images of molded plaques of a thermoplastic composition of the present invention a polar polymeric additive (10 wt. % PE-AA) pretreated with acidic manganese colloid obtained by mixing thermoplastic compositions of the present invention with different polar polymeric additives. The manganese colloid containing acid solution was prepared by mixing H₃PO₄ (219 mL/L), H₂SO₄ (573 mL/L or 605 mL/L), MnO₂ (60 g/L). All pretreatments were conducted at 70° C. Top SEM is pretreatment used 573 mL/L H₂SO₄ and for 10 min. Second SEM is pretreatment used 605 mL/L H₂SO₄ and pretreatment was for 10 min. Third SEM used 573 mL/L H₂SO₄ and for 20 min. Bottom SEM used 605 mL/L H₂SO₄ and pretreatment was for 20 min.

FIG. 8 shows transmission electron microscopy (TEM) images a comparative composition and a thermoplastic compositions of the present invention with a polar polymer (C) (3 wt. % PE-AA and 10 wt. % PE-AA) before surface treatment. Bottom TEM represents the changes in the top surface region (skin layer) after surface treatment of the comparative composition with 3 wt. % PE-AA. The changes are marked by arrows.

FIG. 9 are graphical illustrations of peel strength measurements and repeatability of metalized plaques that include the thermoplastic compositions of the comparative sample (top graph) and of the present invention (3 wt. % (left graph) and 10 wt. % PE-AA (right graph)) after hexachrome acid etching.

FIG. 10 are graphical illustrations of peel strength measurements of metalized plaques that include the thermoplastic compositions of the comparative sample (top graph) and of the present invention (3 wt. % PE-AA (middle graph) and 10 wt. % PE-AA (bottom graph)) after pretreatment with acidic manganese colloid solution at different time (10 and 20 mins).

FIG. 11 are graphical illustrations of average peel force on metalized plaques that include comparative sample (C11) and the thermoplastic compositions of the present invention (3 wt. % PE-AA (F10) and 10 wt. % PE-AA (F11)) after hexachrome acid etching.

FIG. 12 are graphical illustrations of average peel force on metalized plaques that include the comparative sample (C10) and thermoplastic compositions of the present invention (3 wt. % PE-AA (F10) and 10 wt. % PE-AA (F11)) after pretreatment with acidic manganese colloid at different concentrations and times.

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to at least one of the problems associated with thermoplastic compositions that are to be metal plated and/or reduced yellow index of the composition. In one aspect, the invention can include a thermoplastic composition that includes greater than 1 wt. % to 15 wt. % of a polar polymer (C) that contains a carboxylic acid, an alcohol, an amide, or a combination thereof. Advantageously, the polar polymer (C), together with the aforementioned copolymer (A) and the aforementioned thermoplastic polymer (B) can allow the thermoplastic composition of the present invention to be surface treated for metal plating without the need for using hexavalent chromium compounds for etching. Advantageously, the thermoplastic composition in a molded form has a suitable impact strength, thereby allowing such a polymeric article to be used for preparing metal plated articles suitable for various industrial application that desire a material to have excellent impact strength. The thermoplastic compounds of the present invention can also have an improved yellowness index (YI) and/or whiteness as compared to thermoplastic compounds that do not contain polar polymer (C).

These and other non-limiting aspects of the present invention are discussed in further detail in the following sections.

### A. Thermoplastic Composition

The thermoplastic composition of the present invention can include (a) 30 wt. % to 79 wt. % of the copolymer (A), (b) 20 wt. % to 50 wt. % of the rubber modified thermoplastic polymer (B), (c) greater than 1 wt. % to 15 wt. %, preferably 2 wt. % to 13 wt. %, more preferably 3 wt. % to 10 wt. % of the polar polymer (C), and (d) greater than 0 wt. % to 5 wt. %, of optional processing additives. The thermoplastic composition can be molded or formed into a polymeric article. The polymeric article can have a suitable impact property necessary for certain application including door handles, holders, lamp bodies, corporate logos, and other decorative components used in the automotive industry, household appliance, electronics, furniture, sanitary fittings, and others. For example, the polymeric article can have a Notched Izod Impact strength of ≥3.0 kJ/m² and ≤30.0 kJ/m² or any range or value there between. For example, the Notched Izod Impact strength can be 3.0 kJ/m², 4.0 kJ/m², 5 kJ/m², 10 kJ/m², 15 kJ/m², 20 kJ/m², 25 kJ/m², 30 kJ/m², or ≥3.0 kJ/m² and ≤30.0 kJ/m², ≥4.0 kJ/m² and ≤25.0 kJ/m², ≥5.0 kJ/m² and ≤20.0 kJ/m², when measured in accordance with ISO 180/1A. The thermoplastic composition of the present invention can have a yellowness index from 2 to 30, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or any range or value there between. Yellowness index can be measured using known methodology. A non-limiting example of yellowness index method is ASTM E313-20. The thermoplastic polymer composition can have increased white lightness (e.g., appear whiter) as compared to the thermoplastic polymer composition absent polar polymer (C). A white lightness value can range from greater than 85, preferably 85 to 92, more preferably 86 to 90. White lightness can be measured using known methodology. A non-limiting example of determining white lightness is to CIELAB color space analysis.

### 1. Copolymer (A)

Copolymer (A) can include polymeric units derived from (i) a vinyl aromatic monomer, and (ii) a vinyl nitrile monomer. Based on the total weight of the thermoplastic composition, the copolymer (A) can be present in an amount of greater than or equal to 30.0 wt. % and less than or equal to 79.0 wt. % or any range or value there between. For example, 30 wt. %, 35 wt. %, 40 wt. %, 45 wt. %, 50 wt. %, 55 wt. %, 60 wt. %, 65 wt. %, 70 wt. %, 75 wt. %, and 79 wt. %, or ≥36.0 wt. % and ≤78.0 wt. %, ≥60.0 wt. % and ≤75.0 wt. %, and ≥62.0 wt. % and ≤74.0 wt. %, with regard to the total weight of the thermoplastic polymer composition.

In some embodiments of the invention, the copolymer (A) has: ≥22.0 wt. % and ≤38.0 wt. % or any range or value there between of polymeric units derived from the vinyl nitrile monomer, with regard to the total weight of the copolymer (A). For example, 22 wt. %, 23 wt. %, 24 wt. %, 25 wt. %, 26 wt. %, 27 wt. %, 28 wt. %, 29 wt. %, 30 wt. %, 31 wt. %, 32 wt. %, 33 wt. %, 34 wt. % 35 wt. %, 36 wt. %, 37 wt. %, 38 wt. % or ≥25.0 wt. % and ≤35.0 wt. %, ≥30.0 wt. % and ≤35.0 wt. %, of polymeric units derived from the vinyl nitrile monomer, with regard to the total weight of the copolymer (A). In a preferred aspect, the copolymer (A) can have ≥30.0 wt. % and ≤35.0 wt. %, of polymeric units, derived from the vinyl nitrile monomer, with regard to the total weight of the copolymer (A).

Non-limiting example of vinyl aromatic monomers can include styrene, α-methyl styrene, dibromostyrene, vinyltoluene, vinylxylene, butylstyrene, p-hydroxystyrene, methoxystyrene, or any combination thereof. Non-limiting examples of vinyl nitrile monomers include acrylonitrile, alpha-chloro acrylonitrile, methacrylonitrile, ethacrylonitrile, or any combination thereof. In a preferred aspect, the vinyl aromatic monomer is styrene and the vinyl nitrile monomer is acrylonitrile. Preferably, the copolymer (A) is styrene acrylonitrile (SAN) copolymer. In preferred embodiments of the invention, the copolymer (A) is styrene acrylonitrile copolymer having ≥30.0 wt. % and ≤35.0 wt. %, of polymeric units derived from acrylonitrile.

In some aspects of the invention, the copolymer (A) can, for example, be a terpolymer comprising polymeric units derived from (i) a vinyl aromatic monomer, (ii) a vinyl nitrile monomer, and (iii) (meth)acrylic monomers. The vinyl aromatic monomer and the vinyl nitrile monomer can be selected from monomers as defined above. Non-limiting examples of (meth)acrylic monomers can include methyl methacrylate, ethyl methacrylate, propyl methacrylate, iso-propyl methacrylate, butyl methacrylate, hexyl methacrylate, and decyl methacrylate. Preferably, the (meth) acrylic monomer may be methyl methacrylate (MMA). Accordingly, the copolymer (A) can be a terpolymer that includes polymeric units derived from styrene/acrylonitrile/methylmethacrylate, or from alpha-methyl-styrene/acrylonitrile/methyl methacrylate.

Copolymer (A) can have a suitable molecular weight and melt flow rate. An average molecular weight (Mw) of copolymer (A) can be ≥50,000 g/mol and ≤100,000 g/mol or any range or value there between. For example, 50,000 g/mol, 55,000 g/mol, 60,000 g/mol, 65,000 g/mol, 70,000 g/mol, 75,000 g/mol, 80,000 g/mol, 85,000 g/mol, 90,000 g/mol, 95,000 g/mol, 100,000 g/mol, or ≥80,000 g/mol and ≤100,000 g/mol, ≥85,000 g/mol and ≤98,000 g/mol, ≥93,000 g/mol and ≤97,000 g/mol as determined in accordance with gel permeation chromatography in accordance with ASTM D5296-11 using polystyrene based calibration with tetrahydrofuran (TIF) as solvent.

Melt flow rate of copolymer (A) can be ≥7.0 g/10 min and ≤20.0 g/10 min or any value or range there between as determined at 230° C. at 1.2 kg load in accordance with ISO 1133 (2005). For example, 7.0 g/10 min, 8.0 g/10 min, 9 g/10 min, 10 g/10 min, 11 g/10 min, 12 g/10 min, 13 g/10 min, 14 g/10 min, 15 g/10 min, 16 g/10 min, 17 g/10 min, 18 g/10 min, 19 g/10 min, 20 g/10 min, or ≥8.0 g/10 min and ≤15.0 g/10 min, ≥9.0 g/10 min and ≤11.0 g/10 min. If the melt flow rate of the copolymer (A) is above these rates, the overall impact property of the thermoplastic polymer composition can be adversely affected whereas if the melt flow rate of the copolymer (A) is below these rates, the desired flow property of the thermoplastic polymer is not attained, affecting the melt-processability of the thermoplastic polymer.

### 2. Rubber Modified Thermoplastic Polymer (B)

In an aspect of the invention, the thermoplastic polymer composition can include a suitable amount of a rubber component. The rubber modified thermoplastic polymer (B) can be referred to as high rubber graft or “HRG”. The thermoplastic polymer composition can include at least 26.0 wt. % of the rubber modified thermoplastic polymer (B). In some aspects, the thermoplastic polymer composition can include the rubber modified thermoplastic polymer (B) present in an amount of greater than or equal to 20.0 wt. % and less than or equal to 50.0 wt. % or any range or value there between. For example, 20 wt. %, 25 wt. %, 30 wt. %, 35 wt. %, 40 wt. %, 45 wt. %, 50 wt. %, or ≥30.0 wt. % and ≤45.0 wt. %, ≥20.0 wt. % and ≤30.0 wt. %, ≥22.0 wt. % and ≤24.0 wt. %, with regard to the total weight of the thermoplastic polymer composition.

In some aspects, the thermoplastic polymer composition can include copolymer (A) in an amount of ≤79.0 wt. %, while the rubber modified thermoplastic polymer (B) in an amount of ≥20.0 wt. % with regard to the total weight of the thermoplastic polymer composition. The rubber modified thermoplastic polymer (B) can include (i) a polymeric rubber, (ii) a thermoplastic copolymer (D) grafted to the polymeric rubber. In some embodiments of the invention, the polymeric rubber can be a discontinuous elastomeric phase dispersed across a continuous rigid thermoplastic phase that includes the thermoplastic copolymer (D), with at least a portion of the rigid thermoplastic phase being grafted to the discontinuous elastomeric phase. The polymeric rubber can have a suitable particle-based morphology. For example, the polymeric rubber may be in the form of a rubber particles having a broad, monomodal particle size distribution. For example, the polymeric rubber can have an average particle diameter of ≥50 nanometers (nm) and ≤1000 nanometers (nm) and any range or value there between. In a preferred aspect, the polymeric rubber can have an average particle diameter of ≥200 nanometers (nm) and ≤500 nanometers (nm).

The rubber modified thermoplastic polymer (B), can include a suitable amount of the polymeric rubber. The rubber modified thermoplastic polymer (B) can include a polymeric rubber content of ≥55.0 wt. % and ≤75.0 wt. % or any value or range there between. For example, the polymeric rubber content can be ≥55.0 wt. % and ≤75.0 wt. %, ≥57.0 wt. % and ≤70.0 wt. %, ≥60.0 wt. % and ≤65.0 wt. %, ≥60.0 wt. % and ≤63.0 wt. %, with regard to the total weight of the rubber modified thermoplastic polymer (B). The polymeric rubber content may for example be determined using Fourier Transform Infrared Micro-Spectroscopy (FT-IR). Accordingly, the rubber modified thermoplastic polymer (B) can have a grafted thermoplastic copolymer (D) content of ≥25.0 wt. % and ≤45.0 wt. % or any range or value there between. For example, the content of grafted thermoplastic copolymer (D) can be 25 wt. %, 30 wt. %, 35 wt. %, 40 wt. %, 45 wt. % or ≥25.0 wt. % and ≤45.0 wt. %, ≥30.0 wt. % and ≤43.0 wt. %, ≥35.0 wt. % and ≤40.0 wt. %, ≥37.0 wt. % and ≤40.0 wt. %, with regard to the total weight of the rubber modified thermoplastic polymer (B). In some aspects of the present invention, the rubber modified thermoplastic polymer (B) can have a polymeric rubber content of ≥55.0 wt. % and ≤75.0 wt. %, ≥57.0 wt. % and ≤70.0 wt. %, ≥60.0 wt. % and ≤65.0 wt. %, ≥60.0 wt. % and ≤63.0 wt. %, and a grafting thermoplastic copolymer (D) content of ≥25.0 wt. % and ≤45.0 wt. %, ≥30.0 wt. % and ≤43.0 wt. %, ≥35.0 wt. % and ≤40.0 wt. %, ≥37.0 wt. % and ≤40.0 wt. %, with regard to the total weight of the rubber modified thermoplastic polymer (B). More preferably, the rubber modified thermoplastic polymer (B) can have a polymeric rubber content of ≥60.0 wt. % and ≤65.0 wt. %, more preferably ≥60.0 wt. % and ≤63.0 wt. %, and a grafting thermoplastic copolymer (D) content of ≥35.0 wt. % and ≤40.0 wt. %, preferably ≥37.0 wt. % and ≤40.0 wt. %, with regard to the total weight of the rubber modified thermoplastic polymer (B).

The polymeric rubber can include polymeric units derived from a conjugated diene. Non-limiting examples of the conjugated diene include 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, and any combination thereof, preferably the conjugated diene is 1,3-butadiene. In some aspects of the present invention, the conjugated diene can be 1,3-butadiene and the polymeric rubber can be polybutadiene.

The rubber modified thermoplastic polymer (B) can include the grafted thermoplastic copolymer (D) grafted to the polymeric rubber. Grafted thermoplastic copolymer (D) can include polymeric units derived from (i) a vinyl aromatic monomer, (ii) a vinyl nitrile monomer, and (iii) an optional (meth)acrylic monomer. Non-limiting examples of a vinyl aromatic monomer include styrene, α-methyl styrene, dibromostyrene, vinyltoluene, vinylxylene, butylstyrene, p-hydroxystyrene, methoxystyrene, and any combination thereof. Non-limiting examples of vinyl nitrile monomers include acrylonitrile, methacrylonitrile, ethacrylonitrile, and any combinations thereof. Non-limiting examples of a (meth)acrylic monomer include methyl methacrylate, ethyl methacrylate, and propyl methacrylate. In a preferred aspect, the vinyl aromatic monomer is styrene, the vinyl nitrile monomer is acrylonitrile, and the optional (meth)acrylic monomer is MMA.

In some embodiments, the grafted thermoplastic copolymer (D) can include polymeric units derived from styrene, methyl methacrylate and acrylonitrile and the polymeric rubber is polybutadiene rubber can include polymeric units derived from 1,3-butadiene. In some aspects, the rubber modified thermoplastic polymer (B) is polybutadiene rubber grafted with a copolymer that includes polymeric units derived from styrene, MMA, and acrylonitrile.

### 3. Polar Polymer (C)

The polar polymer (C) can include a carboxylic acid, an alcohol, and/or an amide, or any combinations thereof, and be present in a suitable amount in the thermoplastic polymer composition. For example, the thermoplastic composition can include ≥1.0 wt. % and ≤15.0 wt. % or any range or value there between. For example, 1 wt. %, 5 wt. %, 10 wt. % 15 wt. % or ≥1.0 wt. % and ≤13.0 wt. %, ≥3.0 wt. % and ≤10.0 wt. %, with regard to the total weight of the thermoplastic polymer composition. Non-limiting examples of polar polymer (C) include an ethylene-acrylic acid copolymer, a polyvinylpyrrolidone (PVP) polymer, a polyvinyl alcohol (PVA) polymer, or a blend thereof. Representative structures of these compounds are shown in Scheme I, where in EAA x=1.6×10² to 8×10² and y=4.8 to 35; in PVA n=1.1×10² to 5.5×10²; in PVP n=45 to 2.2×10².

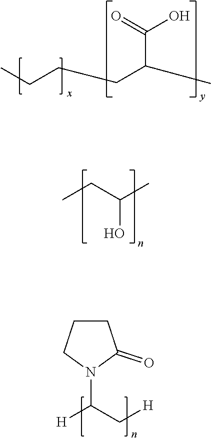

The ethylene-acrylic acid copolymer can include 1 wt. % to 10 wt. % or any range or value there between of acrylic acid, based on the total weight of the ethylene-acrylic acid copolymer. For example, 1 wt. %, 2 wt. %, 3 wt. %, 4 wt. %, 5 wt. %, 6 wt. %, 7 wt. %, 8 wt. %, 9 wt. %, 10 wt. %, 1 wt. % to 10 wt. %, 2 wt. % to 8 wt. %, 3 wt. % to 7 wt. % acrylic acid based on the total weight of the ethylene-acrylic acid copolymer. The polyvinyl alcohol polymer can include 70 wt. % to 80 wt. % or any value or range there between of hydrolyzed polyvinyl acetate based on the total weight of the polyvinyl alcohol. For example, 70 wt. %, 71 wt. %, 72 wt. %, 73 wt. %, 74 wt. %, 75 wt. %, 76 wt. %, 77 wt. %, 78 wt. %, 79 wt. %, 80 wt. % or 70 wt. % to 80 wt. %, or 73 wt. % to 78 wt. % based on the total weight of the polyvinyl alcohol.

Polar polymer (C) can be oligomeric or have a low molecular weight. A weight average molecular weight of polar polymer (C) can be from 5,000 g/mol to 25,000 g/mol or any range there between. For example, 5,000 g/mol, 10,000 g/mol, 15,000 g/mol, 20,000 g/mol, 25,000 g/mol, or ≥5,000 g/mol and ≤18,000 g/mol, and ≥10,000 g/mol, ≤18,000 g/mol, and ≥12,000 g/mol and ≤18,000 g/mol. The determination of molecular weight for example was made using gel permeation chromatography in accordance with ASTM D5296-11 using polystyrene based calibration with tetrahydrofuran (THF) as solvent.

### 4. Melt-Processing Additives

The thermoplastic polymer composition can include an optional processing additive in an amount of ≥0.0 wt. % and ≤5.0 wt. % or any range or value there between based on the total weight of the thermoplastic composition. For example, 0.1 wt. %, 1 wt. %, 1.5 wt. %, 2 wt. %, 2.5 wt. %, 3 wt. %, 3.5 wt. %, 4 wt. %, 4.5 wt. %, 5 wt. %, or ≥1.0 wt. % and ≤5.0 wt. %, ≥1.0 wt. % and ≤2.0 wt. %, preferably ≥1.5 wt. % and ≤2.5 wt. %, based on the total weight of the thermoplastic polymer composition.

Non-limiting examples of a processing additive can include magnesium oxide (MgO), silicone oil, ethylene bis(stearamide) wax, (EBS wax), magnesium stearate or a mixture thereof. In a preferred aspect, a mixture of magnesium oxide (MgO), silicone oil, EBS wax, and magnesium stearate can be used. In some embodiments of the invention, the MgO can be present in amount of ≥0.01 wt. % and ≤0.1 wt. %, or ≥0.01 wt. % and ≤0.05 wt. %, with regard to the total weight of the thermoplastic polymer composition. In some embodiments of the invention, the silicone oil may for example be present in amount of ≥0.05 wt. % and ≤0.5 wt. %, or ≥0.1 wt. % and ≤0.5 wt. %, with regard to the total weight of the thermoplastic polymer composition. In some embodiments of the invention, the EBS wax can be present in amount of ≥0.5 wt. % and ≤2.0 wt. %, or ≥0.8 wt. % and ≤1.5 wt. %, with regard to the total weight of the thermoplastic polymer composition. In some embodiments of the invention, the magnesium stearate can be present in an amount of ≥0.05 wt. % and ≤0.5 wt. %, or ≥0.1 wt. % and ≤0.4 wt. %, with regard to the total weight of the thermoplastic polymer composition.

### 5. Other Additives

The thermoplastic composition can include other additives depending on the application of use. For example, the thermoplastic composition can include an amount of additives of 0 and 20 wt. %, preferably ≥0 and ≤20 wt. % or between 0.5 wt. % and ≤20 wt. %, further preferred between 0.5 to 15 wt. %, further preferred between 0.5 to 12 wt. % or between 0.5 to 8 wt. % based on the total weight of the layer, wherein the sum of the polymer(s) and the additives may preferably be 100 wt. % based on the total weight of the layer.

Non-limiting examples of additives that can be used include anti-fogging agents (e.g., a glycerol ester), an antioxidant, a heat stabilizer, a hindered amine light stabilizer, a flow modifier, an UV absorber, an impact modifier, a coupling agent, a colorant, etc., or any combinations thereof.

Coupling agents can include maleic anhydride grafted polyethylene, maleic anhydride grafted polypropylene, or a combination that includes at least one of the foregoing. Non-limiting examples of commercially available coupling agents include Polybond® 3150 maleic anhydride grafted polypropylene from Chemtura (U.S.A.), Fusabond® P613 maleic anhydride grafted polypropylene, from DuPont (U.S.A.), and Priex® 20097 maleic anhydride grafter polypropylene homopolymer from Addcomp (Germany). The polymeric matrix can include, based on the total weight of the polymeric matrix, 0.1 to 5 wt. % coupling agent or greater than or substantially equal to any one of, or between any two of 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, and 5.0 wt. % of coupling agent.

Non-limiting examples of antioxidants include sterically hindered phenolic compounds, aromatic amines, a phosphite compound, carbon black and the like. Non-limiting examples of phenolic antioxidants include 2,6-di-tert-butyl-4-methylphenol (CAS No. 128-37-0), pentaerythritol-tetrakis(3-(3,5-di-tert-butyl-4-hydroxyphenyl)propionate (CAS No. 6683-19-8),octadecyl 3-(3′,5′-di-tert-butyl-4-hydroxyphenyl)propionate (CAS No. 2082-79-3), 1,3,5-trimethyl-2,4,6-tris-(3,5-di-tert-butyl-4-hydroxybenzyl)benzene (CAS No. 1709-70-2), 2,2′-thiodiethylenebis(3,5-di-tert-butyl-4-hydroxyphenyl)propionate (CAS No. 41484-35-9), calcium bis(ethyl 3,5-di-tert-butyl-4-hydroxybenzylphosphonate) (CAS No. 65140-91-2), 1,3,5-tris(3′,5′-di-tert-butyl-4-hydroxybenzyl)-isocyanurate (CAS No. 27676-62-6), 1,3,5-tris(4-tert-butyl-3-hydroxy-2,6-dimethylbenzyl)-1,3,5-triazine-2,4,6-(1H,3H,5H)-trione (CAS No. 40601-76-1), ethylene bis[3,3-bis(3-tert-butyl-4-hydroxyphenyl)butyrate](CAS No. 32509-66-3), 4,4′-thiobis(2-tert-butyl-5-methylphenol) (CAS No. 96-69-5), 2,2′-methylene-bis-(6-(1-methyl-cyclohexyl)-para-cresol) (CAS No. 77-62-3), 3,3′-bis(3,5-di-tert-butyl-4-hydroxyphenyl)-N,N′-hexamethylenedipropionamide (CAS No. 23128-74-7), 2,5,7,8-tetramethyl-2-(4′,8′,12′-trimethyltridecyl)-chroman-6-ol (CAS No. 10191-41-0), 2,2-ethylidenebis(4,6-di-tert-butylphenol) (CAS No. 35958-30-6), 1,1,3-tris(2-methyl-4-hydroxy-5′-tert-butylphenyl)butane (CAS No. 1843-03-4), 3,9-bis(1,1-dimethyl-2-(beta-(3-tert-butyl-4-hydroxy-5-methylphenyl)propionyloxy)ethyl)-2,4,8,10-tetraoxaspiro[5.5]undecane (CAS No. 90498-90-1;), 1,6-hexanediyl-bis(3,5-bis(1,1-dimethylethyl)-4-hydroxybenzene)propanoate) (CAS No. 35074-77-2), 2,6-di-tert-butyl-4-nonylphenol (CAS No. 4306-88-1), 4,4′-butylidenebis(6-tert-butyl-3-methylphenol (CAS No. 85-60-9); 2,2′-methylenebis(6-tert-butyl-4-methylphenol) (CAS No. 119-47-1); triethylene glycol-bis-(3-tert-butyl-4-hydroxy-5-methylphenyl)propionate (CAS No. 36443-68-2), a mixture of C13 to C15 linear and branched alkyl esters of 3-(3′,5′-di-tert-butyl-4′-hydroxyphenyl)propionic acid (CAS No. 17090-93-0), 2,2′-thiobis(6-tert-butyl-para-cresol) (CAS No. 90-66-4), diethyl-(3,5-di-tert-butyl-4-hydroxybenzyl)phosphate (CAS No. 976-56-7), 4,6-bis (octylthiomethyl)-ortho-cresol (CAS No. 110553-27-0), benzenepropanoic acid, octyl 3-(3,5-di-tert-butyl-4-hydroxyphenyl)propanoate (CAS No. 125643-61-0), 1,1,3-tris[2-methyl-4-[3-(3,5-di-tert-butyl-4-hydroxyphenyl)propionyloxy]-5-tert-butylphenyl]butane (CAS No. 180002-86-2), mixed styrenated phenols (CAS No. 61788-44-1), butylated, octylated phenols (CAS No. 68610-06-0), butylated reaction product of p-cresol and dicyclopentadiene (CAS No. 68610-51-5).

Non-limiting examples of phosphite antioxidant include one of tris(2,4-di-tert-butylphenyl)phosphite (CAS No. 31570-04-4), tris(2,4-di-tert-butylphenyl)phosphate (CAS No. 95906-11-9), bis(2,4-di-tert-butylphenyl)pentaerythritol diphosphite (CAS No. 26741-53-7); and tetrakis (2,4-di-butylphenyl)-4,4′-biphenylene diphosphonite (CAS No. 119345-01-6), and bis (2,4-dicumylphenyl)pentaerythritol diphosphite (CAS No. 154862-43-8).

Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of hindered amine light stabilizers include dimethyl succinate polymer with 4-hydroxy-2,2,6,6-tetramethyl-1-piperidine ethanol (CAS No. 65447-77-0); poly[[6-((1,1,3,3-tetramethylbutyl)amino)-1,3,5-triazine2,4diyl][(2,2,6,6-tetramethyl-4-piperidyl)imino]hexamethylene[2,2,6,6-tetramethyl-4-piperidyl)imino]](CAS No. 70624-18-9); and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane (CAS No. 106990-43-6).

Non-limiting examples of heat stabilizers include phenothiazine, p-methoxyphenol, cresol, benzhydrol, 2-methoxy-p-hydroquinone, 2,5-di-tert-butylquinone, diisopropylamine, and distearyl thiodipropionate (CAS No. 693-36-7). In a preferred embodiment, distearyl thiodipropionate which is sold under the trade name Irganox® PS 820 (BASF, Germany) is used.

Non-limiting examples of antioxidants include a mixture of at least two of 1,3,5-trimethyl-2,4,6-tris-(3,5-di-tert-butyl-4-hydroxybenzyl) benzene sold under the trade name of Irganox® 1330 (BASF, Germany), tris[2,4-bis(2-methyl-2-propanyl)phenyl]phosphite sold under the trade name of Irgafos® 168 (BASF, Germany), pentaerythritol-tetrakis (3-(3,5-di-tert-butyl-4-hydroxyphenyl) propionate sold under the trade name Irganox® 1010 (BASF, Germany), 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane sold under the trade name of Chimassorb 119 (BASF, Germany) is used.

Other additives can include stabilizers, UV absorbers, impact modifiers, and cross-linking agents. A non-limiting example of a stabilizer can include Irganox® B225, commercially available from BASF. In a still further aspect, neat polypropylene can be introduced as an optional additive. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include elastomers/soft blocks dissolved in matrix-forming monomer(s), such as, for example, bulk HIPS, bulk ABS, reactor modified PP, Lomod, Lexan EXL, and/or the like, thermoplastic elastomers dispersed in matrix material by compounding, such as, for example, di-, tri-, and multiblock copolymers, (functionalized) olefin (co)polymers, and/or the like, pre-defined core-shell (substrate-graft) particles distributed in matrix material by compounding, such as, for example, MBS, ABS-HRG, AA, ASA-XTW, SWIM, and/or the like, or combinations thereof. Non-limiting examples of cross-linking agents include divinylbenzene, benzoyl peroxide, alkylenediol di(meth)acrylates, such as, for example, glycol bisacrylate and/or the like, alkylenetriol tri(meth)acrylates, polyester di(meth)acrylates, bisacrylamides, triallyl cyanurate, triallyl isocyanurate, allyl(meth)acrylate, diallyl maleate, diallyl fumarate, diallyl adipate, triallyl esters of citric acid, triallyl esters of phosphoric acid, or combinations thereof.

### B. Process of Making the Thermoplastic Composition

The process for producing the thermoplastic composition can involve melt blending of copolymer (A), modified rubber polymer (B), polar polymer (C), and optional processing additives (D) described in Section A to form an extruded composition. The extruded composition can be further processed to form a molded article. For example, the combination of extrusion and injection molding can be used to form a molded thermoplastic composition of the present invention. In one aspect, the copolymer (A), the rubber modified thermoplastic polymer (B), the polar polymer (C), and optionally the additive mixture can be introduced into an extruder and extruded to form an extruded form. The form can be any form, for example, pellets, spheres, or the like. The extruded form can be subjected to conditions suitable to produce a molded thermoplastic composition. For example, thermoplastic pellets of the present invention can be injected molded into bars, sheets, or a form. Injection molding temperature can be ≥210.0° C. and ≤250.0° C., or any range or value there between. For example, injection molding temperature can be 210° C., 220° C., 230° C., 240° C., 250° C. or ≥215.0° C. and ≤240.0° C., and ≥220° C. and ≤230° C. or any range or value there between. An injection speed of ≥10.0 mm/sec and ≤40.0 mm/sec or any range or value there between can be utilized. For example, an injection speed can be 10 mm/sec, 15 mm/sec, 20 mm/sec, 25 mm/sec, 30 mm/sec, 35 mm/sec, 40 mm/sec, or ≥15 mm/sec and ≤35.0 mm/sec, ≥25.0 mm/sec and ≤30.0 mm/sec or any value or range there between. In some embodiments of the invention, injection molding may be conducted at an injection molding temperature of ≥210.0° C. and ≤250.0° C., preferably ≥215.0° C. and ≤240.0° C., more preferably ≥220° C. and ≤230° C. and at an injection speed was maintained at ≥10.0 mm/sec and ≤40.0 mm/sec, preferably ≥15 mm/sec and ≤35.0 mm/sec, more preferably ≥25.0 mm/sec and ≤30.0 mm/sec.

The process can include physical blending of the ingredients prior to introducing the ingredients into a hopper of the extruder. For example, in some embodiments of the invention, prior to loading to a hopper, the pellets of the polar polymer (C) and the copolymer (A) may be pre-mixed in a container to obtain a set of pellets mixed homogeneously and subsequently introduced into the hopper along with a pre-blend that includes the rubber modified thermoplastic polymer (B) and the optional processing additives. In some embodiments, the physically mixed formulations, once introduced into the extruder via the hopper, can be melt blended. For example, melt blended in a 10-barrel Coperion ZSK-26 mm co-rotating twin-screw extruder with a L/D ratio of 40:1. The condition for extrusion can be conducted at a suitable torque, at a specific mechanical energy, at a specific RPM, or a combination thereof. Extrusion torque can be ≥30.0% and ≤75.0%, preferably ≥40.0% and ≤70.0%, more preferably ≥50.0% and ≤65.0%. A specific mechanical energy can be ≥0.10 kWh/t and ≤0.25 kWh/t, preferably ≥0.12 kWh/t and ≤0.22 kWh/t; and the extrusion screw Rotation Per Minute (RPM) can be ≥170 and ≤260. In some aspects, the material throughput can be adjusted to be maintained between ≥8.0 Kg/hour and ≤30.0 Kg/hour, ≥10 Kg/hour and ≤25.0 Kg/hour, with the specific mechanical energy (SME) being between 0.15 kWh/t and 0.22 kWh/t, and the screw RPM at 250.

### C. Surface Treated Polymeric Article

In some embodiments of the invention, the thermoplastic composition of the present invention can be surface treated. Surface treatment can include contacting at least a portion of the thermoplastic composition (e.g., a molded thermoplastic composition) of the present invention with a chemical reagent for a sufficient time period (e.g., ≥5.0 minutes and ≤30.0 minutes, preferably ≥10.0 minutes and ≤20.0 minutes, preferably ≥15.0 minutes and ≤20.0 minutes) to form the surface treated thermoplastic composition. Contact temperature can range from 60° C. to 80° C. or ≥60.0° C. to ≤80.0° C., preferably ≥65.0° C. to ≤75.0° C. In some embodiments, the thermoplastic composition of the present invention can be contacted with a chemical reagent for any time period between ≥15.0 minutes and ≤20.0 minutes and at a temperature of ≥65.0° C. and ≤75.0° C. The surface treated polymeric article can have suitable surface polarity while retaining the desired impact strength. The attributes of surface polarity and impact strength can be attributed to a purposeful combination of a suitable polymeric article, a suitable selection of chemical reagent and suitable process parameters of temperature and time period of contact/exposure.

Advantageously, the surface treated polymeric article can be produced without the use of hexavalent chromium compounds thereby avoiding drawbacks associated with conventional etching process using hexavalent chromium compounds. The polymeric article can be contacted with the chemical reagent for a suitable period of time in order to ensure the desired surface roughness is incorporated. For example, if the time period of contacting the polymeric article with the chemical reagent is too high (e.g., greater than 30 min), the surface of the polymeric article can be damaged and if the polymeric article is in contact with the chemical reagent is for too short a time (e.g., less than 5 minutes), the surface morphology of the polymeric article is not sufficiently altered to enable the adhesion of the surface treated polymeric article to a metal layer. The chemical reagent can be suspension of a sulfuric acid solution (70.0 vol. %) manganese oxide colloidal particles suspended in a mineral acid mixture, potassium permanganate solution (6.5 vol. %), or any combination thereof. In some aspects, the chemical reagent can be a colloidal suspension that includes manganese oxide colloidal particles suspended in a mineral acid mixture of sulfuric acid and phosphoric acid. For example for a 1 liter solution, the manganese oxide colloidal particles can be present in an amount of ≥50.0 g/L and ≤70.0 g/L, preferably ≥55.0 g/L and ≤65.0 g/L, the phosphoric acid can be present in an amount of ≥210.0 mL/L and ≤230.0 mL/L, preferably ≥215.0 mL/L and ≤225.0 mL/L, and the sulfuric acid can be present in an amount of ≥560.0 mL/L and ≤580.0 mL/L, preferably ≥570.0 mL/L and ≤575.0 mL/L. The chemical reagent can include sulfuric acid (H₂SO₄) having a molar strength of ≥8.0 M and ≤14.0 M, preferably, ≥9.0 M and ≤12.0 M and/or phosphoric acid having molar strength of ≥2.0 M and ≤6.0 M, preferably ≥3.0 M and ≤5.0 M.

The surface treated thermoplastic composition of the present invention can retain the impact property of the polymeric article even after the surface treatment with the chemical reagent. For example, the surface treated polymeric article can have a Notched Izod Impact strength of 3 kJ/m² to 30 kJ/m² or 3 kJ/m², 5 kJ/m², 10 kJ/m², 15 kJ/m², 20 kJ/m², 25 kJ/m², 30 kJ/m², or ≥4.0 kJ/m² and ≤25.0 kJ/m², ≥5.0 kJ/m² and ≤20.0 kJ/m², or any range or vale there between, when measured in accordance with ISO 180/1A. In one aspect, a thermoplastic composition that includes copolymer SAN in 30 wt. % to 70 wt. % (copolymer (A)), ABS in 20 wt. % to 50 wt. % (copolymer (B)), ethylene-acrylic acid copolymer (polar polymer (C)) in 1 wt. % to 5 wt. % has a Notched Izod Impact strength of 17 kJ/m² to 25 kJ/m².

### D. Metal Plated Thermoplastic Composition

In an aspect of the present invention, the thermoplastic composition of the present invention can be metal plated. The metal plated thermoplastic composition can have a metal layer attached to a portion of the surface treated thermoplastic composition. The metal layer can be can have a peel strength of 0.14 N/mm to 0.35 N/mm or 0.14 N/mm, 0.16 N/mm, 0.2 N/mm, 0.3 N/mm, 0.34 N/mm, or ≥0.14 N/mm and ≤2.0 N/mm, ≥0.16 N/mm and ≤2.0 N/mm, ≥0.2 N/mm and ≤1.5 N/mm, 0.3 N/mm and ≤1.5 N/mm, or any range or value there between as determined in accordance with ASTM B 533-85 (2004).

The metal plated thermoplastic composition of the present invention can be produced by known metal plating techniques. For example, a combination of chemical plating and electroplating can be used to metal plate the thermoplastic composition of the present invention. In one aspect, the surface treated thermoplastic composition can be subjected to the chemical treatment to produce a metal plated precursor material. The metal plated precursor article can be contacted with a metal electrolyte solution at any applied electrical current (e.g., 1.0 Amps and ≤4.0 Amps, and for a time period of 5 minutes and ≤30 minutes) to produce the metal plated article.

The chemical plating can include the steps of (i) sensitizing the surface treated thermoplastic composition with a suitable sensitizing solution for example a solution of SnCl₂/HCl followed by activation with an activating solution for example a solution of PdCl₂/HCl to form an activated article, and (ii) thereafter treating the activated article with monosodium phosphate (NaH2PO4), and a chemical plating solution to obtain the precursor article. Non-limiting examples of the chemical plating solution can include CuSO₄·5H₂O (15 g/L), NaKC₄H₄O₆·4H₂O (30 g/L), HCHO (100 ml/L) and NaOH (4 g/L). Alternatively, the chemical plating solution can include NiSO₄·6H₂O (15 g/L), NaKC₄H₄O₆·4H₂O (30 g/L), HCHO (100 ml/L) and NaOH (4 g/L). The metal electrolyte can be nickel sulfate, copper sulfate, aluminum salts (e.g., aluminum chloride or aluminum sulfate), zinc-based salts (e.g., zinc sulfate or zinc chloride), silver salts (e.g., silver sulfate or silver chloride), or a mixtures zinc and silver salts. The chemical plating process can result in the formation of the metal plated thermoplastic composition. The metal plated thermoplastic composition of the present invention can have a suitable conductivity as required for carrying out the electroplating process. The metal layer can be a copper-based layer, an aluminum-based layer, a nickel-based layer, a zinc-based layer, a gold-based layer, or a silver-based layer, or metal alloy-based layer, preferably the metal layer is a copper-based layer. The metal alloy can be selected from brass. The metal plated thermoplastic composition can be used in door handles, holders, lamp bodies, corporate logos and many other decorative components used in the automotive industry, household appliances, electronics, furniture, sanitary fittings, and the like.

### E. Articles of Manufacture

The thermoplastic composition of the present invention can be formed into an article which is not subjected to the surface treatment and/or does not having a metal coating (e.g., an extrusion molded article, an injection molded article, a compression molded article, a rotational molded article, a blow molded article, an injection blow molded article, a 3-D printed article, a thermoformed article, a foamed article, or a cast film) and comprised in an article of manufacture or is an article of manufacture. Non-limiting examples of articles of manufacture include an exterior and/or interior vehicle part, an exterior and/or interior train part, an exterior and/or interior airplane part, an exterior and/or interior building part, an electrical device part, an electronic device part, an industrial device part, medical packing film and/or component, a medical tray, a blister pack, a medical component container, a food packing film, or a food container.

### EXAMPLES

The present invention will be described in detail by way of specific examples. The following examples are offered for illustrative purposes only and are not intended to limit the invention in any manner. Those of skill in the art will readily recognize a variety of noncritical parameters, which can be changed or modified to yield essentially the same results.

### Example 1

### Preparation of Thermoplastic Compositions of the Present Invention and Comparative Thermoplastic Compositions

All formulations were prepared on a 4 Kg scale. While a mixture of SAN (SABIC®, 556 or 581) pellets (copolymer (A)) and polar polymer (C) was added through the main hopper/feeder, the pre-blend of butadiene rubber (CYCOLAC™ INP 362, rubber modified thermoplastic polymer (B)) along with the processing additives of EBX wax, magnesium stearate, magnesium oxide, and silicone fluid, were fed through the side feeder (See, Table 1). Each formulation contained different types of polar polymer (C) such as ethylene-acrylic acid copolymer, polyvinylpyrrolidone polymer, polyvinyl alcohol polymer at different loadings. The details of the formulations are listed in the Table 1. Comparative thermoplastic samples were prepared by mixing equal amounts of both SAN556 and SAN581 (copolymer (A)) without any polar polymer additives to melt blend with HRG (rubber modified thermoplastic polymer (B)), and the processing additives. Thermoplastic compositions of the present invention were prepared in the same manner as the comparative sample, but before loading to main hopper, the pellets of polar polymer (C) and the mixture of SANs were pre-mixed together in a plastic container to produce homogeneously mixed pellets. Similarly, a pre-blend in the form a homogeneous powder was obtained by dry-blending HRG and the processing additives in a separate plastic container. In each formulations, the two types of SAN (556, 581) taken in equivalent amounts, polyethylene-acrylic acid copolymer (PE-AA) containing 6.9 wt % of acrylic acid, (Nucrel 30707), and polyvinyl alcohol (PVOH) polymer containing 80% hydrolyzed polyvinyl acetate were used.

TABLE 1

| | | | | Processing |
|---|---|---|---|---|
| | | | | additives |
| | | | | MgO (2.59%), |
| | | | | Silicone fluid |
| | | | | (12.98%), EBX |
| | | | Polar | wax (64.93%), |
| | CYCOLAC ™ | | Polymer | Mg-Stearate |
| Code | INP 362 (g) | SAN (g) | (C) (g) | (19.48%) |
| EtcP-C10 | 485.6 | 1484 | 0 | 30.4 |
| EtcP-F10 | 485.6 | 1424 | PE-AA, | 30.4 |
| | | | 3% (60) | |
| EtcP-F11 | 485.6 | 1284 | PE-AA, | 30.4 |
| | | | 10% (200) | |
| EtcP-F13 | 485.6 | 1284 | PVP Mw 10K, | 30.4 |
| | | | 10% (200) | |
| EtcP-F14 | 485.6 | 1284 | PVOH Mw | 30.4 |
| | | | 9K-10K, 10% | |
| | | | (200) | |
| EtcP-C11 | 971.2 | 2967.2* | 0 | 61.6 |
| ETcP-F16 | 1300 | 2398.4** | PE-AA, | 61.6 |
| | | | 6% (240) | |
| EtcP-F15 | 1600 | 1938.4*** | PE-AA, | 61.2 |
| | | | 10% (400) | |

*EtcP-C10 and C-11 used equal amounts of SAN556 and SAN581;
**EtcP-F16 used SAN581;
***ETC-P15 used SAN556, whereas the F10-F14 used both type of SAN (556 & 581) in equal amount.

The physically mixed formulations were melt blended in a 10-barrel Coperion ZSK-26 mm co-rotating twin-screw extruder whose L/D ratio is 40:1. The material throughput during extrusion was adjusted to maintain the specific mechanical energy (SME) between 0.172 and 0.185, while keeping the screw RPM at 250. The temperature profile used during the extrusion and the processing parameters used during the present study are depicted in the Tables 2 and 3, respectively. Table 2 lists the temperature profile used during the extrusion of comparative thermoplastic composition (control) and the formulated thermoplastic compositions of the present invention. Table 3 lists the extrusion details.

TABLE 2

| Barrel | 1^{st} | 2^{nd} | 3^{rd} | 4^{th} | 5^{th} | 6^{th} | 7^{th} | 8^{th} | 9^{th} | 10^{th} |
|---|---|---|---|---|---|---|---|---|---|---|
| Temp. ° C. | 170 | 204 | 225 | 230 | 240 | 240 | 240 | 240 | 240 | 245 |

TABLE 3

| | Torque | | Through | |
|---|---|---|---|---|
| Code | (%) | RPM | put (Kg/h) | SME (kWh/t) |
| C10 | 48-51 | 250 | 14 | 0.172-0.178 |
| F10 | 47-49 | 250 | 14 | 0.171-0.179 |
| F11 | 40-43 | 250 | 13 | 0.172-0.177 |
| F13 | 48-52 | 250 | 16 | 0.175-0.179 |
| F14 | 57-60 | 250 | 18 | 0.174-0.183 |
| C10 | 48-51 | 250 | 14 | 0.172-0.178 |
| F15 | 47-49 | 250 | 14 | 0.217-0.223 |
| F16 | 40-43 | 250 | 13 | 0.182-0.187 |

During the extrusion process, a relatively lower torque value (40-43%) were evident for 10 wt. % PE-AA containing thermoplastic composition (F11), as compared to that observed for the comparative sample (C10, 48-51%), indicating the reduction of melt viscosity. Such reduction of melt viscosity with the incorporation of 10 wt. % PE-AA was attributed to the plasticization effect of EAA owing to its lower molecular weight nature. On the other hand, a slightly higher torque value (57-60%) was evident for the thermoplastic compositions incorporated with 10 wt % of PVOH (F14), possibly indicating the increase of melt viscosity.

Injection molding of test specimens such as ISO tensile bars, ISO impact bars and 3 mm color plaques was carried out in an L&T Detech, 100 Ton molding equipment fitted with 32 mm diameter screw. Injection molding was conducted at a temperature of 240° C. and injection speed was maintained at 20 mm/sec. The molded parts were kept for conditioning for 72 hours at 23° C. and 50% RH.

### Example 2

### Test Results for Thermoplastic Compositions of the Present Invention and Comparative Thermoplastic Compositions

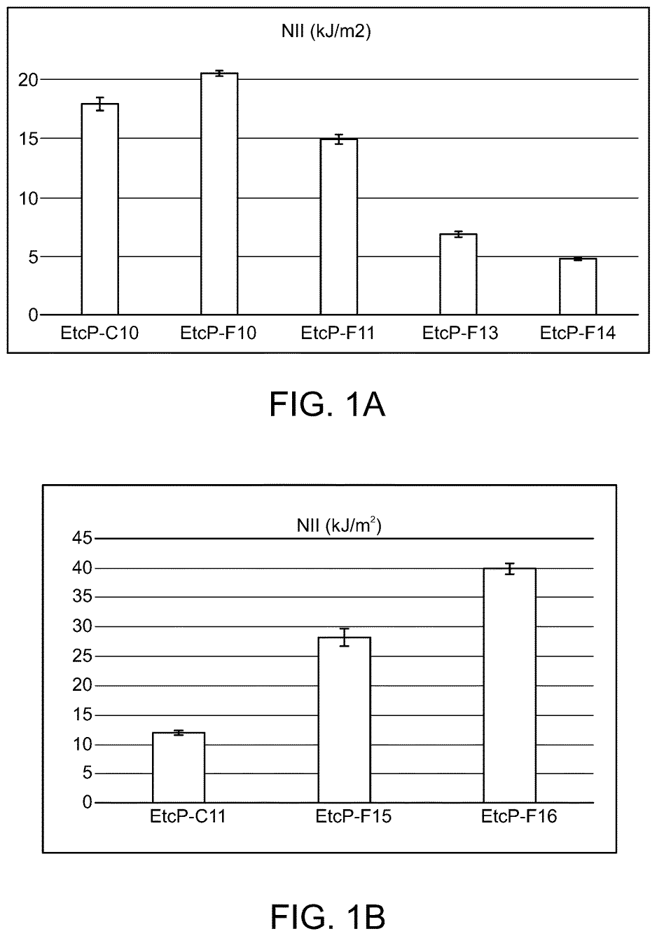

Notched izod impact (NII) properties were measured as per Test ISO 180/1A and are shown in FIG. 1A and FIG. 1B. NII values for the thermoplastic composition incorporated with 3 wt % of polar polymer (C) (F10) are similar or a slightly higher than that of comparative thermoplastic composition (C10). NII values for the thermoplastic composition incorporated with 6 to 10 wt. % of polar polymer (C) (F15 and F16, respectively) are significantly higher than that of comparative thermoplastic composition (C11).

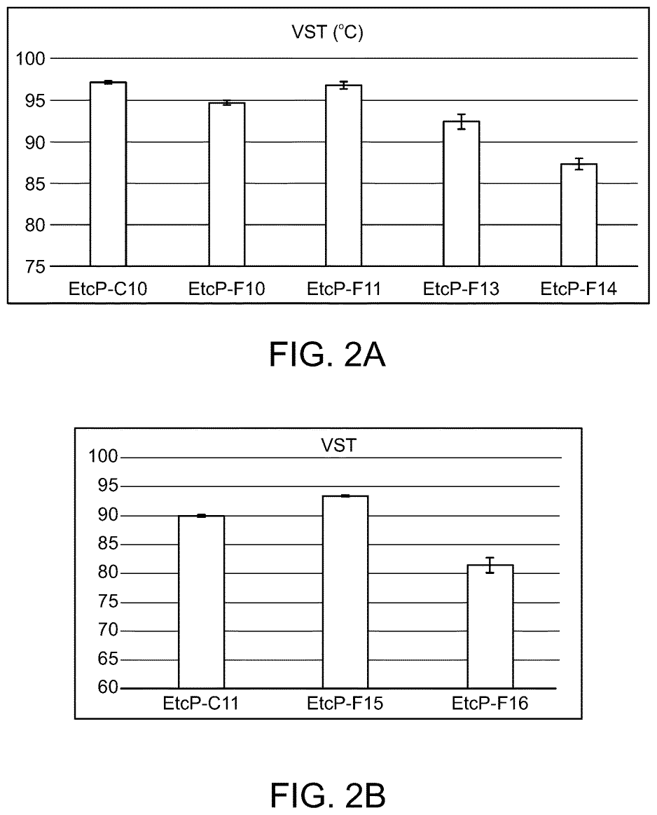

Vicat softening temperature (VST) measurements of the comparative thermoplastic composition and thermoplastic compositions of the present invention were carried out, as per ISO-B120 with 50 N force, using a CEAST equipment fitted with VICAT-6 stations. Results are shown in FIGS. 2A and 2B. VST values of both 3 wt. % (F10), 6 wt. % (F16) and 10 wt. % (F11 and F15) containing PE-AA (polar polymer (C) are comparable to that of comparative thermoplastic compositions without polar polymer (C) (C10, and C11).

Heat Deflection Treatment (HDT) measurement of the comparative thermoplastic composition and the thermoplastic compositions of the present invention were carried out, as per ISO75 with 1.8 MPa and at 120° C./hr, using a CEAST equipment fitted with HDT-6 stations. Results are shown in FIG. 3. The HDT was lowered (from 80° C. to 70° C. for F15 and from 80° C. to 70° C. for F16) as compared to the control ABS (C11).

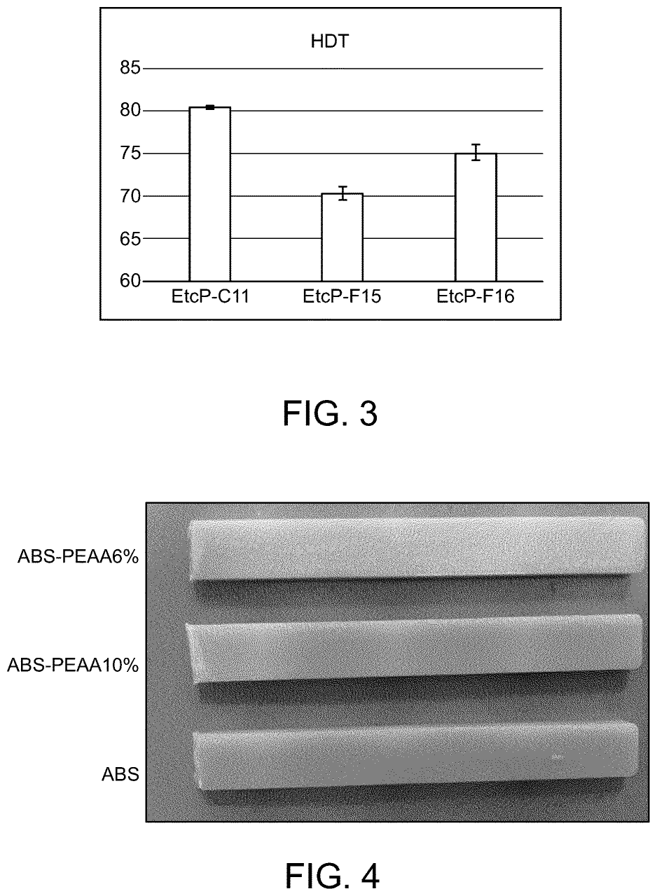

The thermoplastic compositions of some embodiments of the present invention and the control ABS were injection molded into impact bars to determine color differences. As shown in FIG. 4, the visual appearance of the thermoplastic compositions of the present disclosure appeared to be greatly improved, as compared to the control ABS bar. On a relative basis, the thermoplastic compositions of the present invention (F15, F16) appeared more white in color, as compared to the control ABS composition (C11) which does not contain polar polymer (C) and appears darker.

Yellowness Index (YI) measurement was performed as per ASTM E313-20, which was derived from spectrophotometric data and indicated how a test sample's color changes from clear or white to yellow.

As shown in Table 4, the YI of the thermoplastic composition of the present invention (C16) was 7 units lower than that of control ABS composition. A further lowering of YI (by 12 units) was evident for the thermoplastic composition of the present invention with 10 wt. % of polar polymer (C) (C15). Table 4 lists the color measurements using a CIELAB color space analysis. The letters L*, a* and b* represented each of the three values the CIELAB color space used to measure objective color and calculate color differences. L* represented lightness from black to white on a scale of zero to 100, while a* and b* represented chromaticity with no specific numeric limits. Negative a* corresponded with green, positive a* corresponded with red, negative b* corresponded with blue and positive b* corresponded with yellow. The increase of L* by 3 units revealed the increase of white lightness in formulated samples, as compared to the control sample.

TABLE 4

| Sample | | | | | |
|---|---|---|---|---|---|
| code | Sample | L* | a* | b* | YI |
| EtcP-C11 | Control ABS | 83.87 | 0.54 | 17.58 | 33.54 |
| EtcP-F16 | ABS - PE-AA 6% | 86.48 | 0.99 | 13.44 | 26.25 |
| EtcP-F15 | ABS - PE-AA 10% | 86.51 | 1.31 | 10.59 | 21.56 |

### Example 3

### Pretreatment of Molded Plaques of a Comparative Thermoplastic Composition and the Thermoplastic Compositions of the Present Invention

The molded plaques of the comparative thermoplastic composition (C10) and the thermoplastic compositions of the present invention (F10-F14) were pretreated with an acidic manganese colloid solution at various time and concentrations. The incumbent pretreatment etching solution was prepared by mixing CrO₃ and H₂SO₄. With the use of optimal acid pretreatment conditions, a preferred surface morphology was achieved, which enabled mechanical interlocking along with chemical adhesion and provided a strong metal-thermoplastic composition resin interfacial adhesion. The chemicals and the conditions used for pretreatment of molded plaques of the comparative thermoplastic compositions and the formulated thermoplastic composition of the present invention are shown in the Table 5. In case of manganese colloids, the pretreatment time was varied 10 and 20 minutes, as detailed in the Table 5.

TABLE 5

| | | | | Time | |
|---|---|---|---|---|---|
| | Acid name | Concentration | Temp. | (Minutes) | |
| 1 | CrO₃—H₂SO₄ | H₂SO₄ (200 mL/L), | 70° C. | 10 | NA |
| | | CrO₃ (360 g/L) | | | |
| 2 | MnO₂—H₃PO₄—H₂SO₄ | H₃PO₄ (219 mL/L), | 70° C. | 10 | 20 |
| | | H₂SO₄ (573 mL/L), | | | |
| | | MnO₂ (60 g/L) | | | |

### Example 4

### Pretreatment of Molded Plaques of a Comparative Thermoplastic Composition and the Thermoplastic Compositions of the Present Invention with Acidic Colloidal Manganese

For the purpose of direct comparison, the change in surface morphology due to acidic manganese colloid treatment was compared with the sample of same composition subjected to the conventional standard hexachrome based etching process. The molded plaques of the comparative thermoplastic composition (C10) and the thermoplastic composition (with 3 wt. % PE-AA) of the present invention (F10) were pretreated with acidic manganese colloids at two different amounts of sulfuric acid. The acidic manganese colloids were prepared by mixing H₃PO₄ (219 mL/L), H₂SO₄ (573 mL/L and 605 mL/L) and MnO₂ (60 g/L)) at 70° C. for 10 & 20 minutes.

### Example 5

### Analysis of the Comparative Thermoplastic Composition and the Thermoplastic Compositions of the Present Invention Pretreated with Acidic Colloidal Manganese

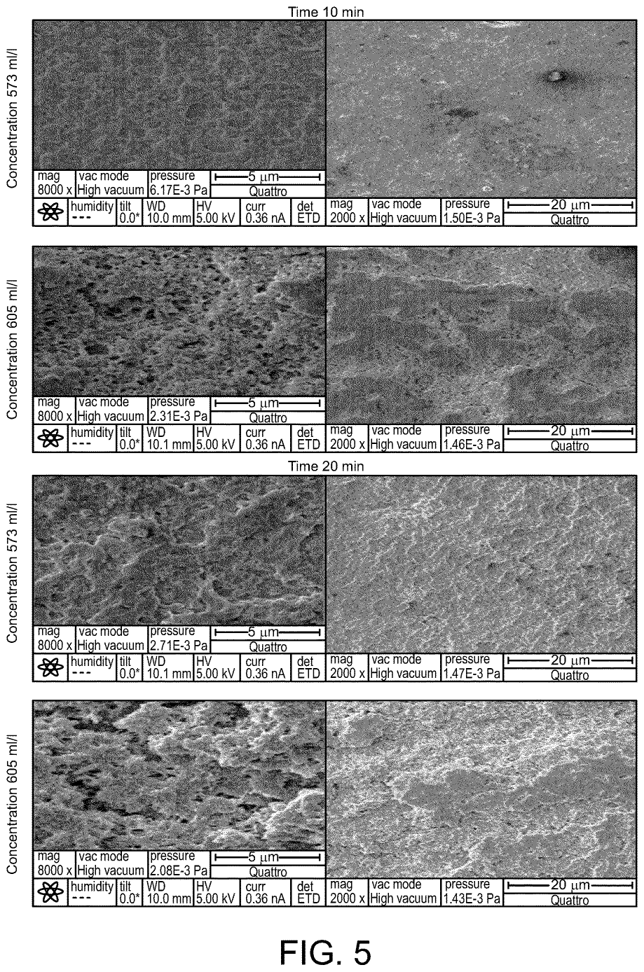

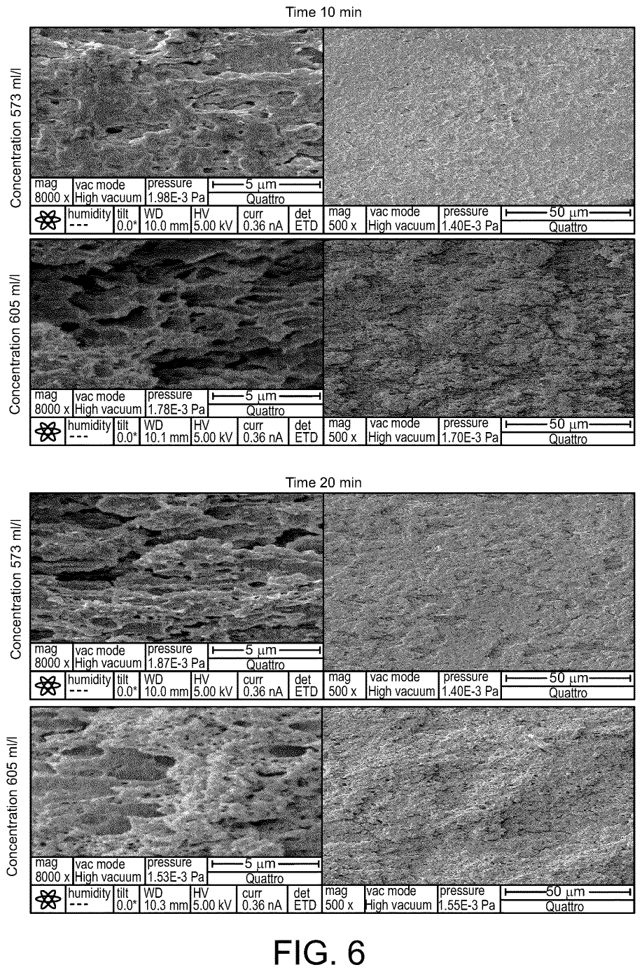

The surface morphology of treated samples for comparative thermoplastic composition (C10) and the 3 wt. % PE-acrylic acid (polymer (C)) incorporated thermoplastic composition (F10) of the present invention, as inferred from SEM microscopy analyses, are shown in FIGS. 5 and 6, respectively. As shown in FIG. 5, there are few minor changes in the surface morphology of thermoplastic composition of the present invention upon the treatment with the acidic manganese colloids at the lower amount of sulfuric acid (prepared by mixing H₃PO₄ (219 mL/L), H₂SO₄ (573 mL/L) and MnO₂ (60 g/L)) at 70° C. for 10 & 20 minutes). When the sulfuric acid concentration was increased in the preparation of the acidic manganese colloids (prepared by mixing H₃PO₄ (219 mL/L), H₂SO₄ (605 mL/L) and MnO₂ (60 g/L)) at 70° C. for 10 & 20 minutes) a significant change in the surface morphology with the appearance of non-uniform cavities was evident. Accordingly, one may conclude that though the pretreatment of molded plaques of the comparative thermoplastic composition with acidic manganese colloid obtained with a lower concentration of sulfuric acid did not lead a significant change in the surface morphology, a similar pretreatment with the use of acidic manganese colloid obtained with a higher concentration of sulfuric acid leads to the creation of roughness as well as the cavities. Apparently, the pretreatment with the use of acidic manganese colloid obtained with a higher concentration of sulfuric acid concentration over a longer duration (20 minutes) led to an over-etched surface, with the appearance of irregular pattern of peaks and valleys.

As shown in the SEM images in FIG. 6, the pretreatment of molded plaques of the thermoplastic composition of the present invention with 3 wt. % of the polar polymer (C) PE-AA (EtcP-F10) with acidic manganese colloid at various sulfuric acid concentrations and duration, led to varying morphological features. For instance, while the pretreatment with H₃PO₄ (219 mL/L), H₂SO₄ (573 mL/L), MnO₂ (60 g/L)) at 70° C. for 10 minutes did not lead to a significant morphological change, a longer pretreatment time (20 minutes) resulted in the formation of tiny cavities at the surface. Additionally, the increase of concentration of sulfuric acid from 573 ml/L to 605 mL/L in the acidic manganese colloid, led to creation of significant number of voids and a skeleton morphology with subsurface undercuts. Such morphological features are similar to those observed for hexachrome etched comparative thermoplastic sample (C10). The presence of subsurface undercuts can enable a strong mechanical interlocking between metal and plastic. To investigate the effect of morphology on metal-plastic interfacial adhesion, all of these formulations were metalized and subsequently tested for peel adhesion.

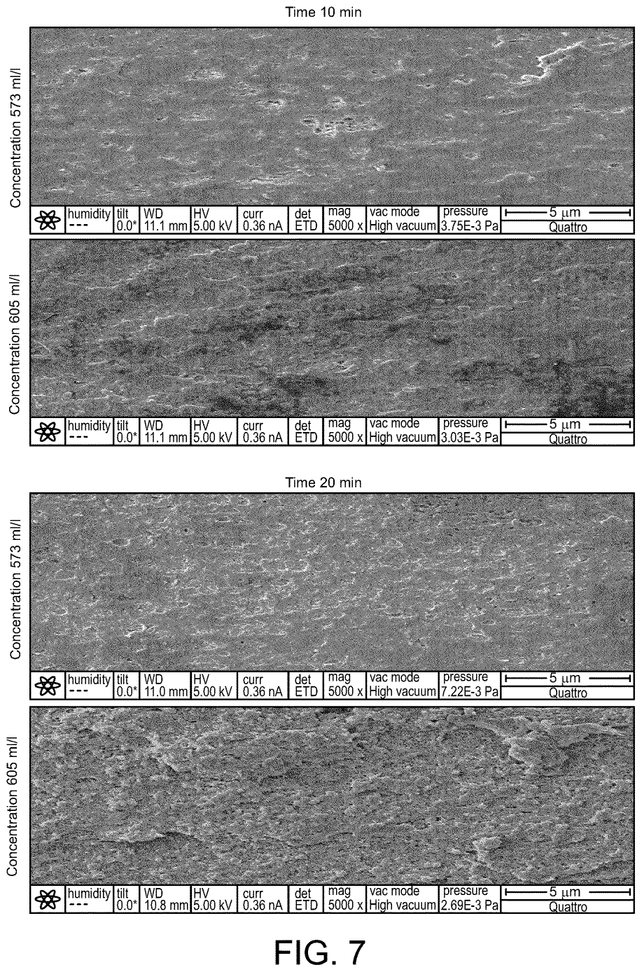

Similar pretreatment experiment was also conducted with the thermoplastic composition incorporated with 10 wt. % of PE-AA of the present invention (F11). In this case, morphological features were evident, irrespective of the change of concentration of sulfuric acid in acidic manganese colloid, as shown in the FIG. 7. However, a different surface morphology was observed with the longer pretreatment time (20 minutes).

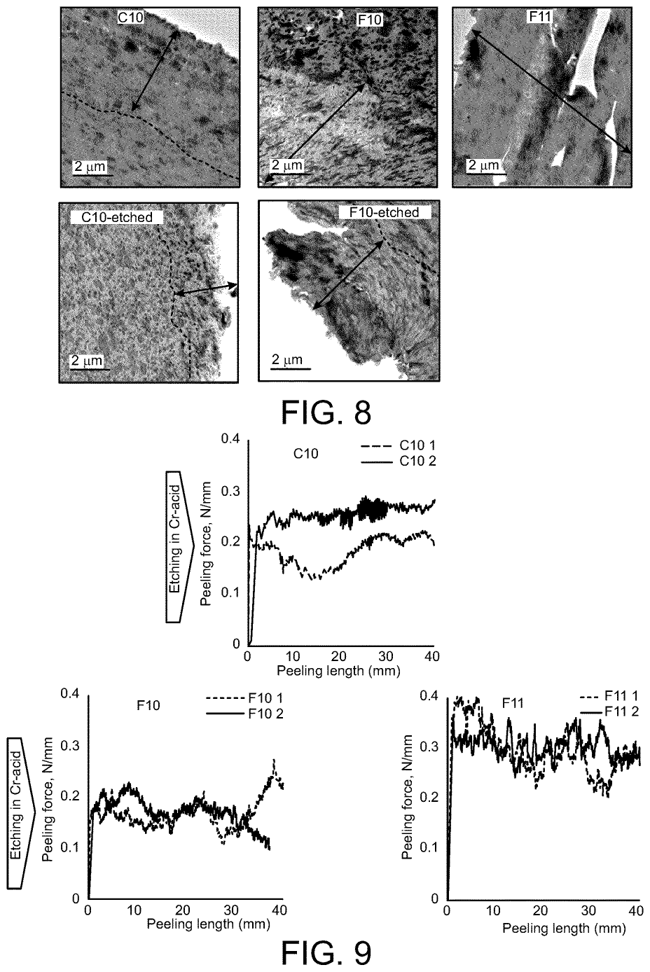

TEM analyses, as depicted in the FIG. 8, of molded plaques of comparative thermoplastic composition (C10) revealed the presence of a skin region with elongated/distorted butadiene rubber domains, which extended up to 3-5 microns, in comparison to the bulk region, which contained rounded domains of varying sizes. In comparison, the skin region of the thermoplastic compositions of the present invention appear to have higher roughness (F10) or even became thicker and extended up to 8-10 microns (F11). However, there are significant changes in the skin region after the etching treatment and the skin region appears thinner due to the removal of portions of the top layers by acid treatment. Representative images of the etched skin region are shown in FIG. 8 for samples C10 and F10 samples.

### Example 6

### Metal Plating of Molded Plaques of a Comparative Thermoplastic Composition and the Thermoplastic Compositions of the Present Invention

### Chemical Plating Process:

General Procedure. A surface of a substrate was chemical plated by placing the substrate in a plating bath where metal ions in the plating bath were reduced and bound to the polar groups of polymeric substrate to form a metallic layer on the surface of the substrate. All the pretreated samples were sensitized in SnCl₂ (10 g/L)/HCl (40 mL/L) solution and activated in PdCl₂ (0.25 g/L)/HCl (2.5 mL/L) solution. The chemical plating bath contained CuSO₄·5H₂O (15 g/L), NaKC₄H₄O₆·4H₂O (30 g/L), HCHO (100 mL/L) and NaOH (4 g/L). All the samples were chemical plated for 15 minutes. Coated samples were tested for their sheet resistance and used for electroplating by the process described below.

### Electroplating Process:

General Procedure. The electrodeposition experiment consisted of a copper deposition step and was carried out using a MiniContact RS Electroplating System. The electrolyte solution consisted of 75 g/L copper sulfate and 200 mL/L sulfuric acid. The applied current was 1.5 Amps and the temperature was 29° C. The plating time for both the comparative thermoplastic composition and the thermoplastic compositions of the present invention was 30 min.

The process conditions for electroplating were optimized with respect to the applied current and the treatment time. Further, a statistically significant trend is identified for the metal growth on the plaques of formulated thermoplastic compositions of the present invention. Furthermore, thickness of metal layer grown on the surface of the plaque appeared to increase when the treatment time was varied from 5 to 30 min.

The different parameters (current and time) need to be considered in order to have a finite control on the metal thickness during the electroplating. To compare the final peel strength of different samples, a constant metal thickness was necessary in order to make sure that the difference in the peel strength arose mainly due to the different adhesion process i.e., chemical versus mechanical. However, in these examples, the surface conductivity for every sample was different depending on the chemical plating step. Due to this, all the samples were cut into the same diameters to maintain the same surface area. The electroplating was conducted on the same day while maintaining pH, electrolyte concentration, applied current, treatment time and temperature unchanged.

### Example 7

### Peel Testing of a Comparative Thermoplastic Composition and the Thermoplastic Compositions of the Present Invention

Thermoplastic compositions of the present invention (PE-AA (3 wt. %, F10) and PE-AA (10 wt. %, F11)) and the comparative sample (C10, ABS) were metalized and tested for peel adhesion. FIG. 9, shows the average peeling forces for C10, F10 and F11 with, along with that observed after the conventional hexachrome acid etching process. While the sample F10 exhibited peel strength values in the range of 0.16-0.27 N/mm, a slightly higher feel strength values are evident for the thermoplastic composition of the present invention, F11.

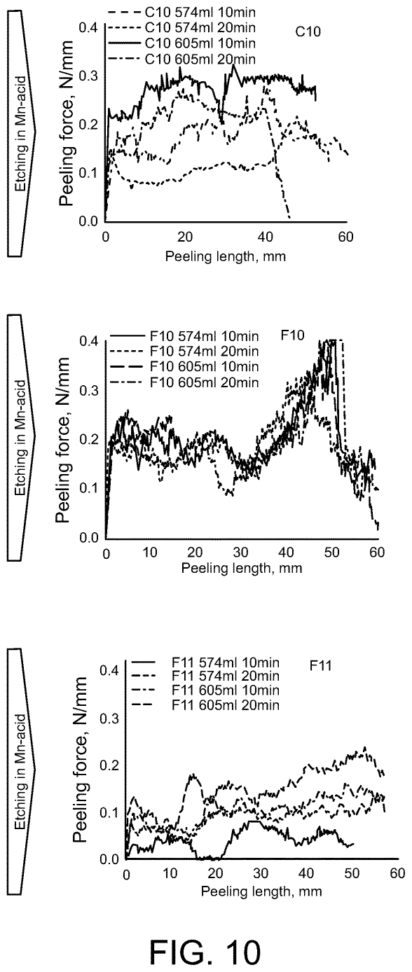

The copper film on the test formulations after pretreatment with manganese colloids acid made with varying concentrations of sulfuric acid (see Example 5) were metalized as described in Example 6 and tested for peel force measurement. FIG. 10, shows the peel test results for both test formulations, F10 and F11 of the present invention as well as the control (C10, ABS). Low loading (3 wt. %) of PE-AA additive (polar polymer (C) of the present invention) into the thermoplastic composition had a metal-plastic adhesion in the range of 0.11-0.25 N/mm. The higher loaded (10 wt. %) of PE-AA additive in the thermoplastic composition of the present invention had a peel force in the range of 0.01-0.22 N/mm. The F10 thermoplastic composition of the present invention (PE-AA (3 wt. %)) etched at low (573 mL/L) concentration of sulfuric acid in the manages colloids for 10 minutes preparation had a better peel force, than that of samples etched for 20 minutes.

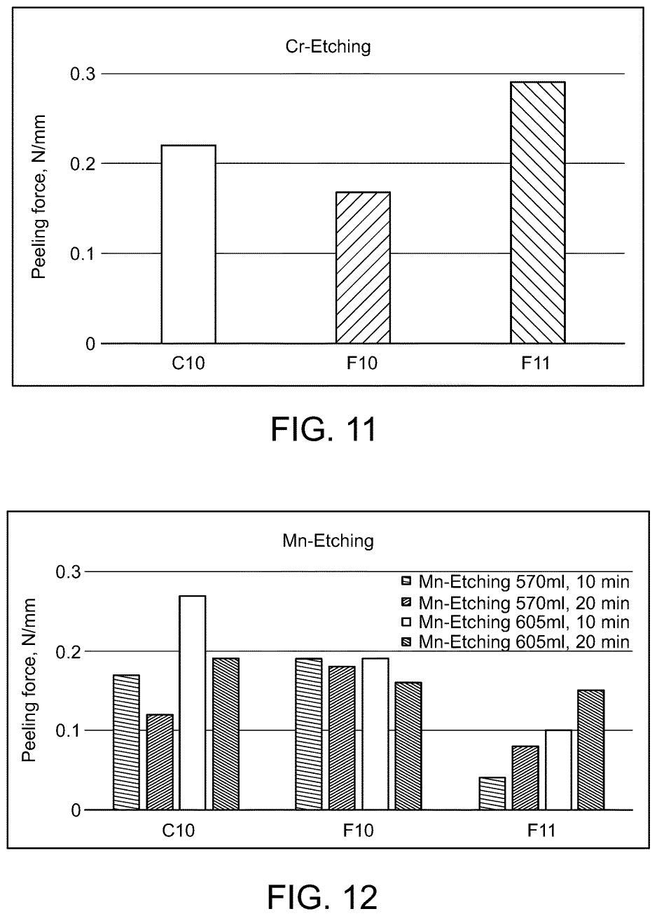

The average peel strength value estimated by considering surface area, was higher (0.29 N/mm) for formulated thermoplastic compositions of the present invention (e.g., F11) than that observed (0.22 N/mm) for the comparative thermoplastic composition (C10), when they were pretreated with conventional hexachrome acid, as shown in FIG. 11.

The peal test results of the comparative thermoplastic composition and formulated thermoplastic compositions of the present invention pretreated with acidic manganese colloid as shown in FIG. 12. The comparative thermoplastic composition had a maximum peel force 0.27 N/mm after pretreatment with (H₃PO₄ (219 mL/L), H₂SO₄ (605 mL/L), MnO₂ (60 g/L)) at 70° C. for 10 minutes. The inventive thermoplastic formulation F10 achieved the best peel force 0.19 N/mm at any sulfuric acid concentration for 10 minutes etching time. Here increasing the etching time slightly reduced the peel force between metal-plastic. In case of another inventive thermoplastic composition, F11, the maximum peel force was achieved 0.15 N/mm after pretreatment with (H₃PO₄ (219 mL/L), H₂SO₄ (605 mL/L), MnO₂ (60 g/L)) at 70° C. for 20 minutes. Interestingly, ABS/PE-AA (3 wt %) exhibits better peel adherence under a treatment with low acid concentration for a similar duration of 10 minutes. This may be intriguing in terms of lowering the price of treatment and speeding up plating, which might result in significant plating cost savings.

From the peeling tests it was determined that using conventional hexachrome acid with high loading of polar polymer (C) (e.g., F11 10 wt. % PE-AA) improved the etch ability as well as adhesion between metal-plastic as compared to the comparative thermoplastic sample (C10). From the results, it was determined that the textures provided using the thermoplastic compositions of the invention provided a better metal-plastic interlocking and good peeling forces as compared to the comparative thermoplastic composition that did not include polar polymer (C).

Although embodiments of the present application and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A thermoplastic polymer composition, comprising, based on the total weight of the thermoplastic polymer composition:
(a) 30 wt. % to 79 wt. % of a copolymer (A) comprising units derived from (i) a vinyl aromatic monomer and (ii) a vinyl nitrile monomer;
(b) 20 wt. % to 50 wt. % of a rubber modified thermoplastic polymer (B);
(c) 1 wt. % to 15 wt. % of a polar polymer (C) comprising a carboxylic acid, an alcohol, an amide, or a combination thereof, wherein the polar polymer (C) has a molecular weight from 5,000 g/mole to 25,000 g/mole; and
(d) a melt-processing additive.

2. The thermoplastic polymer composition of claim 1, comprising:
(a) 60 wt. % to 75 wt. %, preferably 62 wt. % to 74 wt. % of copolymer (A);
(b) 20 wt. % to 30 wt. %, preferably 22 wt. % to 24 wt. % of rubber modified thermoplastic polymer (B);
(c) 1 wt. % to 13 wt. %, preferably 3 wt. % to 10 wt. % of polar polymer (C); and
(d) 1 wt. % to 5 wt. %, preferably 1.2 wt. % to 1.5 wt. % of the processing additive.

3. The polymer composition of claim 1, wherein vinyl aromatic monomer comprises styrene, α-methyl styrene, dibromostyrene, vinyltoluene, vinylxylene, butylstyrene, p-hydroxystyrene, methoxystyrene, or any combination thereof, preferably the vinyl aromatic monomer is styrene, and the vinyl nitrile monomer comprises acrylonitrile, alpha-chloro acrylonitrile, methacrylonitrile, ethacrylonitrile, or any combination thereof, preferably acrylonitrile.

4. The polymer composition of claim 1, wherein the rubber modified polymer (B) comprises:
a polymeric rubber comprising polymeric units derived from a conjugated diene, wherein the conjugated diene comprises 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, or any combination thereof, preferably 1,3-butadiene; and
a grafted thermoplastic copolymer (D), wherein the grafted thermoplastic copolymer (D) is grafted to the polymeric rubber, and wherein the grafting thermoplastic copolymer (D) comprises polymeric units derived from: (i) a vinyl aromatic monomer comprising styrene, α-methyl styrene, dibromostyrene, vinyltoluene, vinylxylene, butylstyrene, p-5 hydroxystyrene, methoxystyrene, or any combination thereof, preferably styrene; (ii) a vinyl nitrile monomer comprising acrylonitrile, methacrylonitrile, ethacrylonitrile, or any combinations thereof, preferably acrylonitrile; and (iii) optionally, a (meth)acrylic monomer comprising methyl methacrylate, ethyl methacrylate, methyl acrylate, ethyl acrylate, propyl acrylate, propyl methacrylate, or any combination thereof, preferably methylmethacrylate (MMA).

5. The thermoplastic polymer composition of claim 1, wherein copolymer (A) is styrene-acrylonitrile copolymer (SAN) and the rubber modified thermoplastic polymer (B) is polybutadiene rubber grafted with styrene/methyl methacrylate/acrylonitrile copolymer.

6. The thermoplastic polymer composition of claim 1, wherein the polar polymer (C) comprises an ethylene-acrylic acid copolymer, a polyvinylpyrrolidone polymer, a polyvinyl alcohol polymer, or a blend thereof.

7. The thermoplastic polymer composition of claim 6, wherein the ethylene-acrylic acid copolymer comprises 1 wt. % to 10 wt. %, preferably 6.9 wt. % acrylic acid, based on the total weight of the ethylene-acrylic acid copolymer and the polyvinyl alcohol polymer comprises 70% to 80% hydrolyzed polyvinyl acetate based on the total weight of the polyvinyl alcohol copolymer.

8. The thermoplastic polymer composition of claim 1, wherein the melt-processing additive comprises magnesium oxide (MgO), silicone fluid, ethylene bis stearamide (EBX) wax, magnesium stearate, or a mixture thereof.

9. The thermoplastic polymer composition of claim 1, wherein a molded portion of the thermoplastic polymer composition is surface treated.

10. The thermoplastic polymer composition of claim 1, having a Notched Izod Impact strength of 3.0 kJ/m² to 30.0 kJ/m², preferably 4.0 kJ/m² to 25.0 kJ/m², more preferably 5.0 kJ/m² to 20.0 kJ/m², when measured in accordance with ISO 180/1A.

11. The thermoplastic polymer composition of claim 1, further comprising a metallic coating adhered to at least a portion of a surface of the thermoplastic polymer composition.

12. The thermoplastic polymer composition of claim 1, wherein the thermoplastic polymer composition is comprised in an article of manufacture, preferably a molded article of manufacture.

13. The thermoplastic polymer composition of claim 1, wherein the thermoplastic polymer composition has a yellowness index (YI) less than the thermoplastic polymer composition without polar polymer (C).

14. The thermoplastic polymer composition of claim 1, wherein the thermoplastic polymer composition has a yellowness index (YI) of less than 30, preferably less than 27, more preferably less than 22, or even more preferably from 2 to 30.

15. A metal plated article of manufacture comprising the thermoplastic polymer composition of claim 1 and a metal adhered to at least a portion of a surface of the thermoplastic polymer composition, wherein the metal comprises copper, chromium, nickel, or a combination or an alloy thereof.

16. A process for producing the thermoplastic polymer composition of claim 1, the process comprising melt-blending a thermoplastic composition, the thermoplastic composition comprising:
(a) 30 wt. % to 79 wt. % of a copolymer (A) comprising units derived from a vinyl aromatic monomer and a vinyl nitrile monomer;
(b) 20 wt. % to 50 wt. % of a rubber modified thermoplastic polymer (B);
(c) 1 wt. % to 15 wt. % of a polar polymer (C) comprising a carboxylic acid, an alcohol, an amide, or a combination thereof, and
(d) a melt-processing additive.

17. The process of claim 16, further comprising:
molding the thermoplastic composition into an article and contacting a surface of the article with a chemical agent under conditions suitable to surface treat the article, wherein the chemical agent preferably comprises a suspension of manganese oxide colloidal particles in a mineral acid mixture comprising sulfuric acid and phosphoric acid; and
subjecting the surface treated article to conditions suitable to adhere a metal layer to at least a portion of the treated surface to produce a metal plated portion of the article.

18. A process for reducing a yellowness index (YI) of the thermoplastic polymer composition of claim 1, the process comprising melt-blending a thermoplastic composition, the thermoplastic composition comprising:
(a) 30 wt. % to 79 wt. % of a copolymer (A) comprising units derived from a vinyl aromatic monomer and a vinyl nitrile monomer;
(b) 20 wt. % to 50 wt. % of a rubber modified thermoplastic polymer (B);
(c) 1 wt. % to 15 wt. % of a polar polymer (C) comprising a carboxylic acid, an alcohol, an amide, or a combination thereof, and
(d) a melt-processing additive.
